(19) United States
(12) Patent Application Publication
(10) Pub. No.: US 2015/0009211 A1
(43) Pub. Date: Jan. 8, 2015

(54) METHOD FOR SETTING AND DETERMINING DIRECTIONS OF PRINCIPAL AXES OF 3D OBJECT

(71) Applicants: Wenfei Jiang, Beijing (CN); Kangying Cai, Beijing (CN); Tao Luo, Beijing (CN)

(72) Inventors: Wenfei Jiang, Beijing (CN); Kangying Cai, Beijing (CN); Tao Luo, Beijing (CN)

(73) Assignee: THOMSON LICENSING, Issy de Moulineaux (FR)

(21) Appl. No.: 14/376,156

(22) PCT Filed: Feb. 3, 2012
(86) PCT No.: PCT/CN12/70871

§ 371 Date: Aug. 1, 2014

(51) Int. Cl. G06T 15/00

(52) U.S. Cl. CPC G06T 15/00
USPC 345/419

(57) ABSTRACT

The invention provides a method for setting the directions of principal axes of a 3D object is provided. The method comprises: for each of any two principal axes, setting the direction of the principal axis according to at least one predefined function, with which the result calculated of the 3D object for the vertices in the positive half space of the principal axis is smaller than or equal to the result for the vertices in the negative half space of the principal axis, wherein a vertex in the positive half space of the principal axis means the one with a coordinate of the principal axis larger than 0, and a vertex in the negative half space of the principal axis means the one with a coordinate of the axis smaller than 0; setting the direction of the third principal axis of to follow the right-hand rule with said two principal axes, wherein the vector for the third axis is the cross product of the vectors for said two principal axes; and displaying a signal of the 3D object with the directions of the principal axes set according to the above steps.

### TECHNICAL FIELD

The present invention generally relates to computer graphics. In particular, the present invention relates to a method for setting the directions of principal axes of a 3D object and a corresponding method for determining the directions of principal axes of a 3D object.

### BACKGROUND

One important task in computer graphics and computer vision is the determination of location and orientation of a 3D object within a specified frame of reference. Typically, this information is also called the pose of the 3D object, which is used in many areas, such as shape alignment, object recognition, and generation of 2D drawing views from 3D models. There are several representations of the pose of a 3D object, including the principal axes, affine transformation, moment invariants, medial axis transform and so on.

Principal component analysis (PCA) is the most commonly used approach to find principal axes of a 3D object. It is a mathematical procedure that uses an orthogonal transformation to convert a set of observations of possibly correlated variables into a set of values of uncorrelated variables called principal components. This transformation is defined in such a way that the first principal component has as high variance as possible (that is, accounts for as much of the variability in the data as possible), and each succeeding component in turn has the highest variance possible under the constraint that it is orthogonal to (uncorrelated with) the preceding components.

Denote a 3D model by

$${M}_{0} = [ \begin{matrix}{x}_{1} & {x}_{2} & {x}_{3} & & {x}_{n} \\ {y}_{1} & {y}_{2} & {y}_{3} & … & {y}_{n} \\ {z}_{1} & {z}_{2} & {z}_{3} & & {z}_{n}\end{matrix} ] ,$$

in which each column represents the coordinates of a vertex. FIG. 1 is a flow chart showing the conventional PCA approach for determining the principal axes of a 3D model.

As shown in FIG. 1, the principal axes of a 3D model can be obtained by the following steps:

Step 101: Calculate the central coordinate of the model,

$$\overline{M} = [ \begin{matrix}\begin{matrix}\overline{x} \\ \overline{y}\end{matrix} \\ \overline{z}\end{matrix} ] ,$$

where

$$\{ \begin{matrix}\overline{x} = \frac{1}{m} {\sum }_{k = 1}^{n} {x}_{k} \\ \overline{y} = \frac{1}{m} {\sum }_{k = 1}^{n} {y}_{k} \\ \overline{z} = \frac{1}{m} {\sum }_{k = 1}^{n} {z}_{k}\end{matrix}$$

Then move the model to make its center lie on the origin.

$$M = [ \begin{matrix}{x}_{1} - \overline{x} & {x}_{2} - \overline{x} & {x}_{3} - \overline{x} & & {x}_{m} - \overline{x} \\ {y}_{1} - \overline{y} & {y}_{2} - \overline{y} & {y}_{3} - \overline{y} & … & {y}_{m} - \overline{y} \\ {z}_{1} - \overline{z} & {z}_{2} - \overline{z} & {z}_{3} - \overline{z} & & {z}_{m} - \overline{z}\end{matrix} ] ,$$

wherein M represents model lying on the calculated origin.

Step 102: Calculate the covariance matrix C=MM^{T} of the model.

Step 103: Calculate the eigen values of the covariance matrix C, λ₁, λ₂, λ₃ (λ₁≧λ₂≧λ₃) and the corresponding eigen vectors \vec{V₁}, \vec{V₂}, \vec{V₃}.

Then the eigen vectors \vec{V₁}, \vec{V₂} and \vec{V₃} are the principal axes (X, Y and Z) and the pose of the 3D model can be indicated. There is a problem in this case that the eigen vectors are direction-ambiguous. FIG. 2 is a diagram showing the problem of the PCA approach in the determination of the directions of principal axes of a 3D object, in this case, a teapot. As shown in FIG. 2, the principal axes of the teapot obtained by PCA could be either the case of (a) or (b), which means that the pose of the teapot is not uniquely determined.

In many 3D applications, the directions of principal axes of an object have to be uniquely determined in advance. For example, similarity comparison is a typical application of 3D mesh processing, in which case when two 3D models are very similar one of the models could be used to represent the other. During the similarity comparison, the directions of the principal axes need to be uniquely determined. However, as described above, the directions of the principal axes obtained by PCA are ambiguous. In view of the above, an intuitive solution could be used in this case to check all the eight combinations of the axis directions. After computing the principal axes of two objects, both the positive and negative direction of the three axes for one model will be used to align the other, and the minimum error among all cases will have to be calculated. Such method could provide a correct result but obviously is not efficient.

Thus it can be seen, traditional PCA cannot determine the positive directions of the principal axes of a 3D object. If the directions of the axes are reversed, the object cannot be correctly aligned. Thus, some related applications, such as similarity comparison described above, may have to try a few times to find the correct directions, which will cause much computational complexity.

Therefore, there is a need for a method to uniquely and quickly determine the directions of principal axes of a 3D object.

### SUMMARY OF INVENTION

According one aspect of the invention, a method for setting the directions of principal axes of a 3D object is provided. The method comprises: for each of any two principal axes, setting the direction of the principal axis according to at least one predefined function, with which the result calculated of the 3D object for the vertices in the positive half space of the principal axis is smaller than or equal to the result for the vertices in the negative half space of the principal axis, wherein a vertex in the positive half space of the principal axis means the one with a coordinate of the principal axis larger than 0, and a vertex in the negative half space of the principal axis means the one with a coordinate of the axis smaller than 0; setting the direction of the third principal axis of to follow the right-hand rule with said two principal axes, wherein the vector for the third axis is the cross product of the vectors for said two principal axes; and displaying a signal of the 3D object with the directions of the principal axes set according to the above steps.

According one aspect of the invention, a method for determining the directions of principal axes of an object in a 3D object set according the above method is provided. The method comprises determining the direction of a principal axis of the 3D object by the following steps: dividing all the vertices of the 3D object into a positive half space and a negative half space by the origin of the principal axis, with a vertex with a coordinate of the principal axis larger than or equal to 0 being in the positive half space of the principal axis, and a vertex with a coordinate of the principal axis smaller than 0 being in the negative half space of the principal axis; setting either direction of the principal axis as the preliminary positive direction of the axis; calculating a first value with a first predefined function for all vertices in the positive half space, and a second value with the first predefined function for all vertices in the negative half space; and determining the positive direction of the principal axis as a function of the disparity of the first value and the second value.

It is to be understood that more aspects and advantages of the invention will be found in the following detailed description of the present invention.

### BRIEF DESCRIPTION OF THE DRAWINGS

The accompanying drawings are included to provide further understanding of the embodiments of the invention together with the description which serves to explain the principle of the embodiments. The invention is not limited to the embodiments.

In the drawings:

FIG. 1 is a flow chart showing the conventional PCA solution for determining the principal axes of a 3D model;

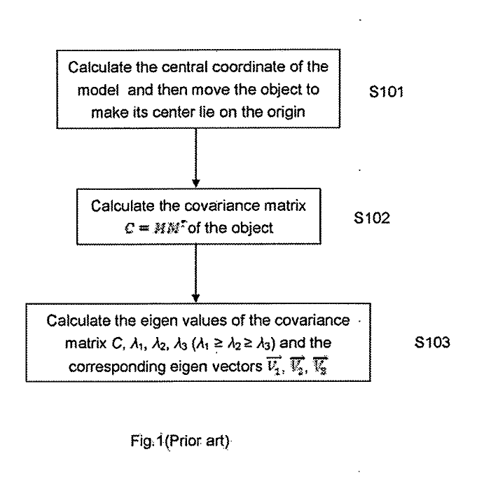

FIG. 2 is a diagram showing the problem of the PCA solution in the determination of the directions of principal axes of a teapot;

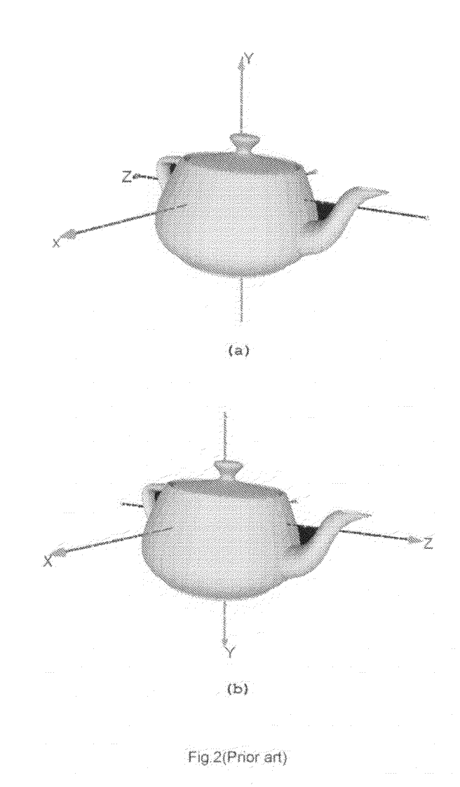

FIG. 3 is a flow chart showing the method for determining the positive direction of one principal axis of a 3D model according to an embodiment of the present invention; and

FIG. 4 is a diagram showing the principle of automatic assembly of screw and nut.

### DETAILED DESCRIPTION

Embodiments of the present invention will now be described in detail in conjunction with the drawings. In the following description, some detailed descriptions of known functions and configurations may be omitted for conciseness.

According to an embodiment of the present invention, for purpose of uniquely and quickly determining the directions principal axes of an object in a 3D model, a method for setting the directions of principal axes of a 3D object is provided, wherein a set of rules for the directions of principal axes of X, Y and Z of the object in the 3D model are setted as follows:

a) For each of any two principal axes, axes X and Y for example, setting the direction of the principal axis as a function of at least one predefined function, with which the result calculated of the 3D object for the vertices in the positive half space of the principal axis is smaller than or equal to result for the vertices in the negative half space of the principal axis, wherein a vertex in the positive half space of the principal axis means the one with a coordinate of the principal axis larger than 0, and a vertex in the negative half space of the principal axis means the one with a coordinate of the axis smaller than 0;

b) Setting the direction of the third principal axis, axis Z in this case, to follow the right-hand rule with the above two principal axes X and Y; and

Then a 3D object can be displayed with the directions of the principal axes set according to the above rules, which can be used in many 3D applications.

With regard to the above rule a), a vertex in the positive half space of the principal axis means the one with a coordinate of the axis larger than 0. A vertex in the negative half space of the axis means the one with a coordinate of the principal axis smaller than 0. Specifically, all the vertices with X coordinates larger than 0 are in the positive half space of the axis X. This is the same for axes Y and Z.

According to the rule a), the result calculated with a predefined function used for determining the direction of axis X for the vertices in the X-positive half space is smaller than or equal to that for the vertices in the X-negative half space. The result calculated with a predefined function used for determining direction of axis Y for the vertices in the Y-positive half space is smaller than or equal to that for the vertices in the Y-negative half space. Axis Z is not mentioned here since its direction can be determined according to rule b) once the directions of X and Y axes are determined, which is described below.

With regard to the above rule b), it means that the vector for axis Z is the cross product of the vectors for axes X and Y. Denote \vec{V₁}, \vec{V₂} and \vec{V₃} the eigen vectors of the principal axes X, Y and Z, respectively. According to rule b), \vec{V₁}×\vec{V₂}=\vec{V₃}. Therefore, once the directions of any two principal axes of the object are determined, the direction of the third principal axis can be uniquely determined.

It can be appreciated that in many cases one function is sufficient to determine the direction of a principal axis. However, if only one function does not work, another one or more functions can be defined for this purpose.

According to another embodiment of the present invention, a method for determining the directions of principal axes of a 3D object set according to the above rules is provided.

Next, process for determining the positive direction of one principal axis (for example, X) of a 3D object will be described in details.

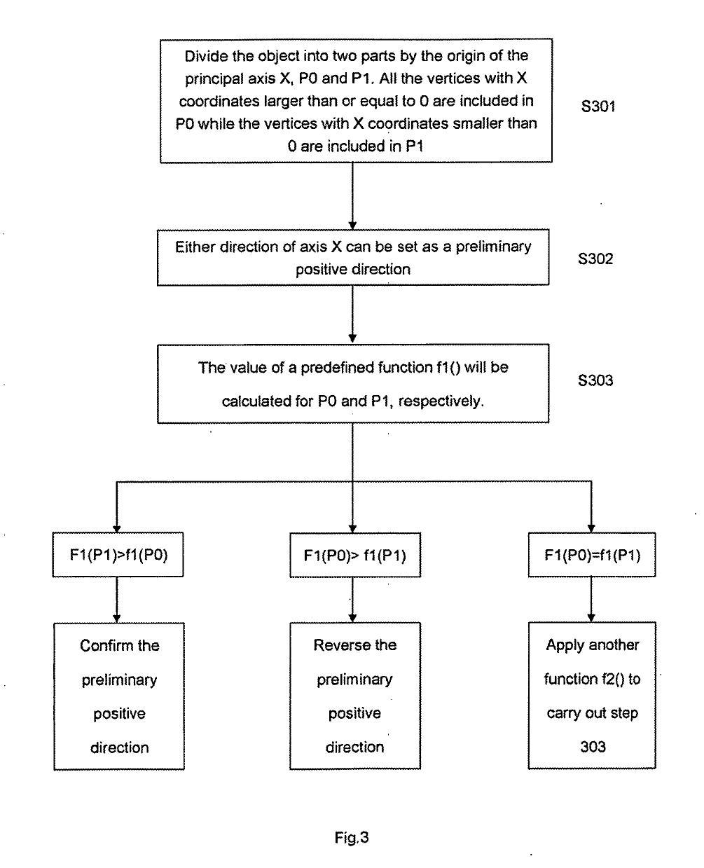

FIG. 3 is a flow chart showing the method for determining the positive direction of one principal axis of a 3D model according to an embodiment of the present invention.

Firstly at a step 301, the object will be divided into two parts by the origin of the axis, P0 and P1. All the vertices with X coordinates larger than 0, that is, in the positive half space of the axis X, are included in P0. The vertices with X coordinates smaller than 0, that is, in the negative half space of the axis X, are included in P1.

Then at a step 302, either direction of axis X can be set as a preliminary positive direction, which might be reversed in the following process.

Next at a step 303, the value with a predefined function, f1() for example, will be calculated for P0 and P1, respectively. For instance, f1() could be defined as f_{y}(U)=Σₖ^{P}|yₖ|, wherein U denotes a set of vertices f_{y}(U) is the sum of the absolute Y coordinates of all vertices included in U. Then fy(P0) is the sum of the absolute Y coordinates of all vertices included in P0.

According to above rule a), if fy(P0)<fy(P1), the above preliminary positive direction is confirmed to be the positive direction of the axis X. If fy(P0)>fy(P1), the preliminary positive direction needs to be reversed. That is, the opposite direction of the above preliminary positive direction needs to be set as the positive direction of the axis X. In the embodiment of the invention, for purpose of determining the axis direction of an object, a function is predefined, with which the result calculated for the vertices in the positive half space of an axis is smaller than or equal to that for the vertices in the negative half space of the that axis. However, it should be noted that the purpose of having the result for the vertices in the positive half space to be smaller than that for the vertices in the negative half space is just for distinguishing the vertices in the positive and negative half spaces, which is then used for the determination of the axis direction. Whether the result for the positive half space is smaller or larger than that for the negative half space is not the point here since it can be appreciated that the results will depend on the predefined function. For example, if the above function fy() makes fy(P0)>fy(P1), then the function −fy() will make fy(P0) <fy(P1).

In this embodiment, if fy(P0)=fy(P1), which means only one function fy() cannot determine the direction of axis X, another function f2()(for example, f_{z}(U)=Σₖ^{P}|zₖ|) can be used to determine the positive direction of the axis X according to the above step 303, which will not be described in details.

If the values with the second function f2() are still equivalent for P0 and P1, that is, f2(P0)=f2(P1), further function f3() or functions fn() can be used. In consideration of the computational complexity, the number of attempts can be limited to 3. i.e., if f3(P0)=f3(P1), which means three functions fail to determine the positive direction, the object is probably symmetric, so the axis determination simply gives a conclusion that both directions may be the positive direction.

With the similar process described above, the positive direction of the second principal axis (for example, Y) of a 3D object will also be determined.

Finally, the positive direction of the third axis (Z in this case) can be determined according to the determined directions of axes X and Y of the object based on the right-handed rule.

Next, an embodiment of the present invention will be described in details in the context of axis alignment for object matching as an illustrative example.

For the applications of object matching, the determination of axis directions needs to be as quick as possible. A simple set of functions can be defined for the above rule a). The input of the functions is a set of vertices denoted by U. The functions are defined as:

fₓ(U)=Σₖ^{P}|xₖ|

[fₓ(U) is the sum of the absolute X coordinates of all vertices included in U.]

fₓ₂(U)=Σₖ^{P}xₖ²

[fₓ₂(U) is the sum of the square of X coordinates of all vertices included in U.]

f_{y}(U)=Σₖ^{P}|yₖ|

[f_{y}(U) is the sum of the absolute Y coordinates of all vertices included in U.]

f_{y2}(U)=Σₖ^{P}yₖ²

[f_{y2}(U) is the sum of the square of Y coordinates of all vertices included in U.]

fₓ(U)=Σₖ^{P}|xₖ|

[f_{z}(U) is the sum of the absolute Z coordinates of all vertices included in U.]

f_{z2}(U)=Σₖ^{P}zₖ²

[f_{z2}(U) is the sum of the square of Z coordinates of all vertices included in U.]

Note that for a number of models, the above six functions might still not be able to uniquely determine the axis directions. However, since the number of axis-direction combinations is reduced to four because of the above rule b), the worst case is to compare the objects for four times and choose the minimum error. Therefore, for this particular application, at most three of the above functions may be chosen to uniquely determine the axis directions of an object. It can be appreciated that fₓ(U) cannot be used for direction determination for axis X since the values of fₓ(U) for the positive & negative parts are equivalent after PCA. Neither can fₓ(U) be used for axis Y. If three functions still cannot achieve the goal, it can be decided to take no further steps but just compare the objects in all ambiguous directions.

It also should be noted that the above six functions are given only for illustrative purpose. More other functions can be used.

Given two objects

$${M}_{0} = [ \begin{matrix}{x}_{1} & {x}_{2} & {x}_{3} & & {x}_{m} \\ {y}_{1} & {y}_{2} & {y}_{3} & … & {y}_{m} \\ {z}_{1} & {z}_{2} & {z}_{3} & & {z}_{m}\end{matrix} ] and {N}_{0} = [ \begin{matrix}{x}_{1}^{′} & {x}_{2}^{′} & {x}_{3}^{′} & & {x}_{n}^{′} \\ {y}_{1}^{′} & {y}_{2}^{′} & {y}_{3}^{′} & … & {y}_{n}^{′} \\ {z}_{1}^{′} & {z}_{2}^{′} & {z}_{3}^{′} & & {z}_{n}^{′}\end{matrix} ] .$$

The alignment method is follows:

Step 401: Move the objects to make their center lie on the origin, obtaining M and N.

$$M = [ \begin{matrix}{x}_{1} - \overline{x} & {x}_{2} - \overline{x} & {x}_{3} - \overline{x} & & {x}_{n} - \overline{x} \\ {y}_{1} - \overline{y} & {y}_{2} - \overline{y} & {y}_{3} - \overline{y} & … & {y}_{n} - \overline{y} \\ {z}_{1} - \overline{z} & {z}_{2} - \overline{z} & {z}_{3} - \overline{z} & & {z}_{n} - \overline{z}\end{matrix} ]$$

$$N = [ \begin{matrix}{x}_{1}^{′} - \overline{x} & {x}_{2}^{′} - \overline{x} & {x}_{3}^{′} - \overline{x} & & {x}_{n}^{′} - {\overline{x}}^{′} \\ {y}_{1}^{′} - \overline{y} & {y}_{2}^{′} - \overline{y} & {y}_{3}^{′} - \overline{y} & … & {y}_{n}^{′} - {\overline{y}}^{′} \\ {z}_{1}^{′} - \overline{z} & {z}_{2}^{′} - \overline{z} & {z}_{3}^{′} - \overline{z} & & {z}_{n}^{′} - {\overline{z}}^{′}\end{matrix} ]$$

Step 402: Calculate the covariance matrix, C_{M}=MM^{T}; derive its eigen values λ1, λ2, λ3 (λ₁≧λ₂≧λ₃) and the corresponding eigen vectors ±\vec{V₁}, ±\vec{V₂}±\vec{V₃}. It is mandatory that the three eigen vectors satisfy ±\vec{V₁}, ±\vec{V₂}±\vec{V₃}.

Step 403: To determine axis X (±\vec{V₁}) of the object M, divide the vertices of the object M into two vertex set: Uᵥ_{₂}={[xₖ, yₖ, zₖ]^{T}|[xₖ, yₖ, zₖ]^{T}∪ M_{PCA},xₖ>0}. and N.

where

$${M}_{PCA} = [ \begin{matrix}\begin{matrix}\overline{{V}_{1}} \\ \overline{{V}_{2}}\end{matrix} \\ \overline{{V}_{3}}\end{matrix} ] M .$$

If f_{y}(U_{v,})<f_{y}(U_{-v,}), then axis X is \vec{V₁};

If f_{y}(U_{v,})>f_{y}(U_{-v,}), then axis is −\vec{V₁};

If f_{y}(U_{v,})=f_{y}(U_{-v,}):
If f_{z}(U_{v,})<f_{z}(U_{-v,}), then axis X is \vec{V₁};
If f_{z}(U_{v,})>f_{z}(U_{-v,}), then axis X is −\vec{V₁};
If f_{z}(U_{v,})=f_{z}(U_{-v,}):
   If fₓ₂(U_{v,})<fₓ₂(U_{-v,}), then axis X is \vec{V₁};
   If fₓ₂(U_{v,})>fₓ₂(U_{-v,}), then axis X is −\vec{V₁};
   If fₓ₂(U_{v,})=fₓ₂(U_{-v,}), then axis X is ±\vec{V₁} (try both directions).

Step 404: To determine axis Y (±\vec{V₂}), divide the vertices of the object M into two vertex set: Uᵥ_{₂}={[xₖ, yₖ, zₖ]^{T}|[xₖ, yₖ,zₖ]^{T} ∈ M_{PCA}, xₖ>0},

and U₋ᵥ_{₂}={[xₖ,yₖ,zₖ]^{T}|[xₖ,yₖ,zₖ]^{T} ∈ M_{PCA},yₖ>0}.

If fₓ(Uᵥ_{₂})<fₓ(U₋ᵥ_{₂}), then axis Y is \vec{V₂};

If fₓ(Uᵥ_{₂})>fₓ(U₋ᵥ_{₂}), then axis Y is −\vec{V₂};

If fₓ(Uᵥ_{₂})=fₓ(U₋ᵥ_{₂}):
If f_{z}(Uᵥ_{₂})<f_{z}(U₋ᵥ_{₂}), then axis Y is \vec{V₂};
If f_{z}(Uᵥ_{₂})>f_{z}(U₋ᵥ_{₂}), then axis Y is −\vec{V₂};
If f_{z}(Uᵥ_{₂})=f_{z}(U₋ᵥ_{₂}):
   If f_{y2}(Uᵥ_{₂})<f_{y2}(U₋ᵥ_{₂}), then axis Y is \vec{V₂};
   If f_{y2}(Uᵥ_{₂})>f_{y2}(U₋ᵥ_{₂}), then axis Y is −\vec{V₂};
   If f_{y2}(Uᵥ_{₂})=f_{y2}(U₋ᵥ_{₂}), then axis Y is ±\vec{V₂} (try both directions). Step 405: Determine the direction of axis Z by the directions of axes X and Y based on the right-handed rule. Then the axes of the object Mare determined.

There are possibly four cases for the determination result:

(A)The axes are uniquely determined;

(B)Axis X is uniquely determined but axis Y has two possible directions (each corresponds to a z-axis-direction);

(C)Axis Y is uniquely determined but axis X has two possible directions (each corresponds to a z-axis-direction);

(D)Both axis X and axis Y have two possible directions, making four combinations of the axes.

Step 406: Carry out the same operations of the above step 402 to the object N, that is, to apply PCA to the object N. The eigen vectors are ±\vec{V₁′}, ±\vec{V₂′}, ±\vec{V₃′}.

Step 407: Carry out the same operations of the above steps 403 and 404 to the object N to uniquely determine the first two axes of the object N. The difference is that only one of the axis directions is chosen when f_{y}(Uᵥ_{₂}′)=fᵥ(U₋ᵥ_{₂}′) or fₓ(Uᵥ_{₂}′)=fₓ(U₋ᵥ′) occurs. It can be either \vec{V₁′} or −\vec{V₁′} (\vec{V₂′} or −\vec{V₂}′).

Step 408: Determine the direction of the axis Z by the directions of axes X and Y of the object N based on the right-handed rule. Then the axes of the object N are uniquely determined.

Align the axes of the object M to the axes of the object N. Then the comparison can be carried out. In the cases that some axes of M are ambiguous, the comparison is made for each alignment.

Next, another embodiment of the present invention will be described in details in the context of automatic assembly as an illustrative example.

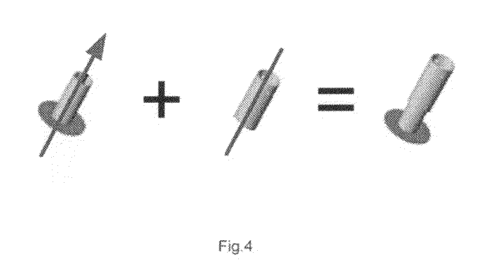

The axis determination of components is a key step in automatic assembly. FIG. 4 is a diagram showing the principle of automatic assembly of a screw and a nut. For instance, the primary principal axis of the screw (shown by the arrow in FIG. 4) has to be correctly determined. Otherwise the nut cannot be screwed on.

As shown in FIG. 4, for purpose of the automatic assembly of the screw and the nut, only one of the axes (shown by the arrow in FIG. 4) is necessary, which is called central axis. The axis determination is based on the specification of the screw and nut. Since the screw is symmetric with respect to the central axis, the other two axes correspond to equivalent eigen values. This feature is used to choose the central axes of the screw. The assembly process is as follows:

Step 501: Determine the principal axes of the screw by PCA. For each screw M, pick the eigen vector that corresponds to a different eigen value from the others as the central axis. Denote it by ±\vec{V₃} (Z axis).

Step 502: To determine direction of the central axis, the following function is defined:

f_{xy}(U)=Σₖ^{P}xₖ²+yₖ²

Divide the vertices of the screw into two vertex sets:

Uᵥ_{₂}={[xₖ,yₖ,zₖ]^{T}|[xₖ,yₖ,]^{T}∈M_{PCA}, zₖ>0},

and U₋ᵥ_{₂}={[xₖ,yₖ,zₖ]^{T}|[xₖ,yₖ,zₖ]^{T} ∈ M_{PCA},zₖ>}.

where

$${M}_{PCA} = [ \begin{matrix}\begin{matrix}\overline{{V}_{1}} \\ \overline{{V}_{2}}\end{matrix} \\ \overline{{V}_{3}}\end{matrix} ] M .$$

If f_{xy}(Uᵥ_{₂})<f_{xy}(U₋ᵥ_{₂}), then central axis is \vec{V₃};

If f_{xy}(Uᵥ_{₂})>f_{xy}(U₋_{₂}), then central axis is −\vec{V₃};

Step 503: Carry out the same operations of the above step 501 to the nut to determine the central axis of the nut ±\vec{V₃′} (Z axis). If the nut is asymmetric with respect to the X-Y plane, carry out the same operations of the above step 502 to determine the direction of central axes of nut. Otherwise, remove the ± sign directly.

Based on the above determination result on the axis direction, the axes of the screw and the nut can be aligned, with the positive central axis of the screw pointing to the nut. Then the screws and nuts can be locked.

As described above, the present invention provides a method for setting the directions of principal axes of a 3D object and a corresponding method for determining the directions of principal axes a 3D object, which can uniquely and quickly determine directions of principal axes of a 3D object.

Although the embodiments of the present invention are described in the context of PCA approach, it can be appreciated for a person skilled in the art that the present invention can be applied to other direction-ambiguous approaches for determining the pose of a 3D object.

1. A method for setting the directions of principal axes of a 3D object, comprising:
for each of any two principal axes, setting the direction of the principal axis according to at least one predefined function, with which the result calculated of the 3D object for the vertices in the positive half space of the principal axis is smaller than or equal to the result for the vertices in the negative half space of the principal axis, wherein a vertex in the positive half space of the principal axis means the one with a coordinate of the principal axis larger than 0, and a vertex in the negative half space of the principal axis means the one with a coordinate of the axis smaller than 0;
setting the direction of the third principal axis of to follow the right-hand rule with said two principal axes, wherein the vector for the third axis is the cross product of the vectors for said two principal axes; and
displaying a signal of the 3D object with the directions of the principal axes set according to the above steps.

2. The method according to claim 1, wherein the at least one predefined function is selected from the following functions:
fₓ(U)=Σₖ^{p}|xₖ|

which is the sum of the absolute X coordinates of all vertices included in U;
fₓ₂(U)=Σₖ^{p}xₖ²
which is the sum of the square of X coordinates of all vertices included in U;
f_{y}(U)=Σₖ^{p}|yₖ|

which is the sum of the absolute Y coordinates of all vertices included in U;
f_{y2}(U)=Σₖ^{p}yₖ^{z}
which is the sum of the square of Y coordinates of all vertices included in U;
f_{z}(U)=Σₖ^{p}|zₖ|

which is the sum of the absolute Z coordinates of all vertices included in U; and
f_{z2}(U)=Σₖ^{p}zₖ²
which is the sum of the square of Z coordinates of all vertices included in U.

3. A method for determining the directions of principal axes of an object in a 3D object as set according to claim 1, comprising determining the direction of a principal axis of the 3D object by the following steps:
dividing all the vertices of the 3D object into a positive half space and a negative half space by the origin of the principal axis, with a vertex with a coordinate of the principal axis larger than or equal to 0 being in the positive half space of the principal axis, and a vertex with a coordinate of the principal axis smaller than 0 being in the negative half space of the principal axis;
setting either direction of the principal axis as the preliminary positive direction of the axis;
calculating a first value (f1(P0)) with a first predefined function (f1()) for all vertices in the positive half space, and a second value (f1(P1)) with the first predefined function (f1()) for all vertices in the negative half space; and
determining the positive direction of the principal axis as a function of the disparity of the first value (f1(P0)) and the second value (f1(P1)).

4. The method according to claim 3, further comprising:
confirming said preliminary positive direction to be the positive direction of the principal axis if the first value is smaller than the second value (f1(P0)<f1(P1));
determining the opposite direction of the said preliminary positive direction to be the positive direction of the principal axis if the first value is larger than the second value (f1(P0)>f1(P1)).

5. The method according to claim 4, further comprising:
if there is no disparity between the first second values calculated with the first predefined function (f1()) (f1(P0)=f1(P1)), using one or more additional predefined functions (f2(), f3()) one by one for the calculation of the new first value (f2(P0), f3(P0)) and the new second value (f2(P1), f3(P1); and
determining the positive direction of the principal axis as a function of the disparity of the new first value (f2(P0), f3(P0)) and the new second value (f2(P1), f3(P1)) calculated with one of the one or more additional predefined functions (f2(), f3()).

6. The method according to claim 5, further comprising:
confirming said preliminary positive direction to be the positive direction of the principal axis if the new first value calculated with one of the one or more additional predefined functions (f2(), f3()) is smaller than the new second value calculated with the additional predefined function (f2(), f3())(f2(P0)<f2(P1), f3(P0)<f3(P1));
determining the opposite direction of the said preliminary positive direction to be the positive direction of the principal axis if the new first value calculated with one of the one or more additional predefined functions (f2(), f3()) is larger than the second value calculated with one of the one or more additional predefined functions (f2(), f3())(f3(P0)>f2(P1), f3(P0)>f3(P1)).

7. The method according to claim 6, further comprising:
setting either direction of the principal axis as the positive direction of the principal axis if no disparity is found with a predetermined number of predefined functions (f3(P0)=f3(P1)).

8. The method according to claim 3, further comprising:
determining the direction of an principal axis according to the right-hand rule when the positive directions of other two principal axes are determined.

9. The method according to claim 3, further comprising:
the determination is carried out after principal axes of the 3D object are obtained by a principal component analysis.
